(19) United States
(12) Patent Application Publication
(10) Pub. No.: US 2026/0226631 A1
(43) Pub. Date: Aug. 6, 2026

(54) ELECTROLYTE SOLUTION AND A METHOD OF MANUFACTURING THEREOF

(71) Applicant: PETROLIAM NASIONAL BERHAD (PETRONAS), Kuala Lumpur (MY)

(72) Inventors: Mohammad Syamzari RAFEEN, Kuala Lumpur (MY); Wan Anas Masyudi WAN ABDULLAH SANI, Kuala Lumpur (MY); Shafiq Bin MOHD HIZAM, Bandar Seri Iskandar, Perak (MY); Nik Abdul Hadi Bin SAPIAA @ MD NORDIN, Bandar Seri Iskandar, Perak (MY); Mohd Dzul Hakim Bin WIRZAL, Bandar Seri Iskandar, Perak (MY); Normi Izati Bt MAT NAWI, Bandar Seri Iskandar, Perak (MY)

(21) Appl. No.: 19/153,085

(22) PCT Filed: Jan. 31, 2024
(86) PCT No.: PCT/MY2024/050005

§ 371 Date: Aug. 1, 2025

(30) Foreign Application Priority Data
Feb. 3, 2023 (MY) PI2023000573

(51) Int. Cl. C25B 1/04

(52) U.S. Cl. CPC C25B 1/04

(57) ABSTRACT

An electrolyte solution comprising an electrolyte, wherein the electrolyte is used in an amount ranging between 1 wt % to 10 wt % of the electrolyte solution; an ionic liquid, wherein the ionic liquid is used in an amount ranging between 1 wt % to 5 wt % of the electrolyte solution; and a solvent, wherein the solvent is used in an amount ranging between 75 wt % to 98 wt % of the electrolyte solution.

### FIELD OF THE INVENTION

The present invention relates to an electrolyte solution and method of manufacturing thereof, in particular the electrolyte solution is used in an integrated system of forward osmosis-electrolysis process.

### BACKGROUND OF THE INVENTION

Electrolysis of water is one of the methods for production of hydrogen since it uses renewable water and produces pure oxygen as a by-product. The electrolysis process decomposes the water (H₂O) into hydrogen (H₂) and oxygen (O₂) using electric current. Alkaline water electrolysis is one of the types of electrolysis in the industry.

The most-used electrolyte for alkaline water electrolysis is potassium hydroxide (KOH) as the specific conductivity is optimal at a temperature ranging between 50° C. to 80° C. Another aspect is the solubility of the product gases inside the electrolyte, as this influences the resulting product gas purity.

Another approach would be to use ionic liquids as electrolytes or as an additive, owing to their outstanding properties. Negligible vapor pressure, non-inflammability, and thermal stability are promising arguments for their utilization in water electrolysis. Furthermore, ionic liquids can be used over a wide electrochemical window. Additionally, ionic liquids also provides high-efficiency water electrolysis at low temperatures. On the other hand, it takes a lot of energy to separate water into hydrogen and oxygen, which leads to higher power consumption as well.

As such, there is a need to identify an electrolyte solution that comprises a mixture of electrolyte and an ionic liquid such that it can enhance the hydrogen and oxygen production rate at lower power consumption.

### SUMMARY OF THE INVENTION

The present invention relates to an electrolyte solution comprising an electrolyte, wherein the electrolyte is used in an amount ranging between 1 wt % to 10 wt % of the electrolyte solution; an ionic liquid, wherein the ionic liquid is used in an amount ranging between 1 wt % to 5 wt % of the electrolyte solution; and a solvent, wherein the solvent is used in an amount ranging between 75 wt % to 99 wt % of the electrolyte solution.

Additional aspects, features and advantages of the invention will become apparent to those skilled in the art upon consideration of the following detailed description of the accompanying drawings and preferred embodiments of the invention.

### LIST OF ABBREVIATIONS

Emim·MeSO₃: 1-ethyl-3-methylimidazolium methanesulfonate
Emim·Otf: 1-ethyl-3-methylimidazolium trifluoromethanesulfonate
H₂: Hydrogen
KOH: Potassium hydroxide
NaCl: Sodium chloride
NaOH: Sodium hydroxide
NaSc: Sodium saccharin

### DETAILED DESCRIPTION OF THE INVENTION

Detailed description of preferred embodiments of the present invention is disclosed herein. It should be understood, however the embodiments are merely exemplary of the present invention, which may be embodied in various forms. Therefore, the details disclosed herein are not to be interpreted as limiting, but merely as the basis for the claims and for teaching one skilled in the art of the invention. The numerical data or ranges used in the specification are not to be construed as limiting.

The present invention relates to an electrolyte solution and method of manufacturing thereof, in particular the electrolyte solution is used in a forward osmosis and electrolysis process.

For the purpose of the present invention and the accompanying claims, the term “liquid feed stream” refers to any feed stream comprising water such as but not limited to wastewater, saline water, seawater, ground water, tap water and rainwater.

First aspect of the present invention discusses on an electrolyte solution, wherein the electrolyte solution comprises:
an electrolyte, wherein the electrolyte is used in an amount ranging between 1 wt % to 10 wt %, preferably 8 wt % of the electrolyte solution. The electrolyte is selected from the group consisting of potassium hydroxide (KOH), sodium hydroxide (NaOH), sodium chloride (NaCl) and mixtures thereof, preferably KOH;
an ionic liquid, wherein the ionic liquid is used in an amount ranging between 1 wt % to 5 wt %, preferably 4 wt % of the electrolyte solution. The ionic liquid is selected from the group consisting of 1-ethyl-3-methylimidazolium trifluoromethanesulfonate (Emim·Otf), 1-ethyl-3-methylimidazolium methanesulfonate (Emim·MeSO₃) and mixtures thereof, preferably Emim·Otf; and
a solvent, wherein the solvent is used in an amount ranging between 75 wt % to 99 wt %, preferably 78 wt % of the electrolyte solution. The solvent is deionized water.

The electrolyte solution further includes an additive, wherein the additive is used in an amount ranging between 0 wt % to 10 wt %, preferably 10 wt % of the electrolyte solution. The additive is sodium saccharin.

Table 1 shows the chemical components and compositions thereof used in the electrolyte solution of the present invention.

TABLE 1
Chemical components and compositions thereof used in
the electrolyte solution of the present invention

| Chemical components | Working range (wt %) | Preferred range (wt %) |
|---|---|---|
| Electrolyte | 1 to 10 | 8 |
| Ionic liquid | 1 to 5 | 4 |
| Solvent | 75 to 99 | 78 |
| Additive | 0 to 10 | 10 |

It should be understood that the additive is optional and is used in integrated process of forward osmosis and electrolysis, and if the electrolyte is to be used in a conventional electrolysis processes the additive can be excluded. The additive is impactful in the integrated process of forward osmosis and electrolysis because it increases the osmotic pressure that subsequently increases the yield of intended gas production, results of which is explained in the example section below.

Second aspect of the present invention discusses on a method of preparing the electrolyte solution, wherein the method comprises the steps of:
i. adding the electrolyte into a container;
ii. adding the ionic liquid into the container of step (i) by means of pump to produce a first mixture;
iii. optionally, adding the additive into the first mixture obtained from step (ii) to produce a second mixture; and
iv. adding the solvent to the second mixture obtained from step (iii) while stirring using stirrers such as but not limited to magnetic stirrer, mechanical stirrer and spatula at a pressure of 1 atm for a duration of 30 minutes or until the mixture dissolve homogenously at a temperature of 25° C. to produce the electrolyte solution of the present invention.

Referring to the method above, step (ii) should be carried out under a fume hood or by using a snorkel arm to prevent the inhalation of the ionic liquid.

Third aspect of the present invention discusses on the application of the electrolyte, wherein the electrolyte of the present invention can be used but not limited to integrated process of forward osmosis and electrolysis, alkaline water electrolysis and other conventional electrolysis processes such as but not limited to electroplating and metal extraction. The electrolyte of the present invention is unfavourable for acidic water electrolysis.

The following example is constructed to illustrate the present invention in a non-limiting sense.

### Test Results

The electrolyte solution of the present invention is prepared using the composition as described in Table 1 adopting a method as described in the second aspect of the present invention and is used in the method as described in the fourth aspect of the present invention.

### Test Results for the Electrolyte Solution

Different electrolytes are tested under the cyclic voltammetry test. The cyclic voltammetry test is used to evaluate the electrochemical potential window of the electrolytes and the corresponding current density at each applied voltage. For the purpose of the present invention, 10 ml of electrolyte is used in a small container with a 3-electrode system for Electrochemical Impedance Spectroscopy (EIS). The electrode system used is platinum plate for both working and counter electrode while the reference electrode used is saturated calomel. The composite electrolyte results show the highest recorded current density based on the response surface methodology (RSM) of each species.

For the purpose of Table 2, Set 1 refers to a conventional electrolyte solution comprising 10 wt % of KOH and 90 wt % of deionized water. Set 2 represents an electrolyte solution of the present invention comprising 4.29 wt % of Emim·Otf, 8.31 wt % of KOH and 97.4 wt % of deionized water. Set 3 represents an electrolyte solution of the present invention comprising 4.3 wt % of Emim·Otf, 8.31 wt % of KOH, 10 wt % of NaSc and 77.39 wt % of deionized water.

Table 2 shows the outcome of the cyclic voltammetry test for electrolytes of the present invention.

TABLE 2
Outcome of the cyclic voltammetry test for
electrolytes of the present invention

| Parameters | Set 1 | Set 2 | Set 3 |
|---|---|---|---|
| Value of applied voltage (V) | 1.23 | 1.23 | 1.23 |
| Current density (mA/cm²) | 21.17 | 34.76 | 34.73 |

Based on Table 2, it is evident that Sets 2 and 3 of the present invention are able to exhibit comparable value of current density. It has to be understood that the higher the current density, the higher the rate of electrolysis as well as the production of hydrogen and oxygen. Further, it is evident that Set 2 and Set 3 of the present invention have higher current density as compared to Set 1, indicating that the Set 2 and Set 3 of the present invention will causes higher production of hydrogen and oxygen in an electrolysis process.

For the purpose of Table 3, Set 1 refers to a conventional electrolyte solution comprising 10 wt % of KOH and 90 wt % of deionized water. Set 2 represents an electrolyte solution of the present invention comprising 5 wt % of Emim·Otf, 10 wt % of KOH and 85 wt % of deionized water. Set 3 represents an electrolyte solution of the present invention comprising 5 wt % of Emim·Otf, 10 wt % of KOH, 10 wt % of NaSc and 75 wt % of deionized water.

Table 3 shows the outcome of the H₂ production along with the current density and specific power consumption for respective electrolytes of the present invention.

TABLE 3
Outcome of the H₂ production along with the current
density and specific power consumption for respective
electrolytes of the present invention.

| Parameters | Set 1 | Set 2 | Set 3 |
|---|---|---|---|
| Value of applied voltage (V) | 2 | 2 | 2 |
| H₂ rate (10⁻⁵ kg/h) | 3.82 | 5.30 | 9.23 |
| Current density (mA/cm²) | 12.18 | 16.15 | 12.91 |
| Specific power consumption (kWh/kg H₂) | 66.97 | 60.93 | 63.30 |

Based on Table 3, it is evident that Set 2 and Set 3 of the present invention have higher current density and H₂ production at lower power consumption as compared to the conventional electrolyte solution (Set 1). This indicates that the Set 2 and Set 3 of the present invention are more efficient in producing H₂ as compared to the conventional electrolyte solution (Set 1).

### Test Results for the Application of the Electrolyte of the Present Invention Using Integrated Process of Forward Osmosis and Electrolysis

A method of generating hydrogen and oxygen from a liquid feed stream through an integrated system of forward osmosis and electrolysis, wherein the method comprising the steps of:
feeding water into an electrolyte solution by means of forward osmosis, wherein the water is drawn from a liquid feed stream that is brought into contact with one side of the forward osmosis membrane by means of a difference in osmotic pressure between the liquid feed stream and the electrolyte solution; and
applying a voltage across the electrolyte solution to generate hydrogen and oxygen, wherein the electrolyte solution is in contact with the other side of the forward osmosis membrane;
   wherein the above-mentioned steps are carried out simultaneously, wherein the electrolyte solution is as described in the first aspect of the present invention and wherein the electrolyte solution further includes an additive.

The method as described above comprises a step of applying a voltage across the electrolyte solution, wherein the voltage is applied in a range of 1.8V to 2.4V. Further, the method as described above comprises a step of feeding water into an electrolyte solution through a forward osmosis membrane by means of forward osmosis, wherein the forward osmosis membrane is wetted with ethanol having a concentration of 99% prior to the use in the method as described above.

The electrolyte solution of the present invention act as a draw solution in the forward osmosis process to draw the water molecules from the liquid feed stream through the forward osmosis membrane by means of forward osmosis. Simultaneously, the electrolyte solution of the present invention act as an electrolyte in the electrolysis process to convert the water molecules into hydrogen and oxygen.

The osmolarity of the electrolyte solution of the present invention is larger than the osmolarity of the liquid feed stream. Also, the osmotic pressure of the electrolyte solution of the present invention is larger than the osmotic pressure of the liquid feed stream. Since the osmotic pressure and osmolarity of the electrolyte solution of the present invention is larger than the osmotic pressure and osmolarity of the liquid feed stream, the water molecules permeates through the forward osmosis membrane from the liquid feed stream to the electrolyte solution by means of forward osmosis. It should be understood that higher the conductivity of an aqueous solution, higher the osmolarity and osmotic pressure of the aqueous solution.

The electrolyte solution of the present invention has a conductivity of at least 36.67 mS/cm, preferably ranging between 36.67 mS/cm to 323.42 mS/cm, and most preferably ranging between 250 mS/cm to 323.42 mS/cm. The liquid feed stream has a conductivity of at least 0.001 mS/cm, preferably ranging between 0.002 mS/cm to 0.01 mS/cm and most preferably ranging between 0.002 mS/cm to 0.005 mS/cm.

The difference in conductivity between the liquid feed stream and the electrolyte solution of the present invention is at least 36.66 mS/cm wherein the electrolyte solution having a higher conductivity than the liquid feed stream, preferably ranging between 36.66 mS/cm bar to 323.23 mS/cm and most preferably ranging between 250 mS/cm to 323.23 mS/cm.

The electrolyte solution that is in contact with the other side of the forward osmosis membrane is in an electrochemical cell. The electrochemical cell comprises an anode and a cathode which allows the voltage to be applied across the electrolyte solution.

When the voltage is applied across the electrolyte solution, the water molecules are converted into hydrogen gas and hydroxide ions at the anode and the hydroxide ions are converted into oxygen gas and water molecules at the cathode.

The net reaction of converting two water molecules into two hydrogen molecule and one oxygen molecule is as below:

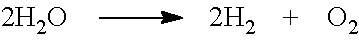

Table 4 shows the hydrogen gas produced at a specific power consumption using a conventional electrolyte solution comprising 10 wt % of KOH and 90 wt % of deionized water as well as the electrolyte solution of the present invention comprising 10 wt % of KOH, 3.69 wt % of Emim·Otf and 86.31 wt % of deionized water adapting the method as described in the second aspect of the present invention.

TABLE 4
Outcome of hydrogen gas produced at a specific power consumption
using KOH as conventional electrolyte solution and the
electrolyte solution of the present invention

| | |
|---|---|
| Specific power | Hydrogen production (ml/h) |

| consumption | Conventional | Electrolyte solution of |
|---|---|---|
| (kWh/kg H₂) | electrolyte solution | the present invention |
| 68 | 182.16 | 435.392 |
| 69 | 242.405 | 474.661 |
| 70 | 302.65 | 513.93 |
| 71 | 362.895 | 553.199 |
| 72 | 423.14 | 592.468 |
| 73 | 483.385 | 631.737 |

Based on Table 4, it is noticeable that the hydrogen gas produced at a specific power consumption using the electrolyte solution of the present invention is higher as compared to the hydrogen gas produced at a specific power consumption using the conventional electrolyte solution, indicating that the electrolyte solution of the present invention as well as the method as described in the second aspect of the present invention reduces the power consumption.

Table 5 shows the water flux by means of forward osmosis from the wastewater to the electrolyte solution of the present invention comprising 10 wt % of KOH, 3.69 wt % of Emim·Otf and 86.31 wt % of deionized water and conventional electrolyte solution comprising 10 wt % of KOH and 90 wt % of deionized water.

TABLE 5
Water flux by means of forward osmosis from the wastewater
to KOH as conventional electrolyte solution and the
electrolyte solution of the present invention

Water flux (L/m²h)

| Flowrate | Conventional | Electrolyte solution of |
|---|---|---|
| (ml/min) | electrolyte solution | the present invention |
| 75 | 6.56 | 7.56 |
| 150 | 7.24 | 8.03 |
| 225 | 8.32 | 8.53 |
| 300 | 8.34 | 8.86 |

Based on Table 5, it is noticeable that the water flux by means of forward osmosis from the wastewater to the electrolyte solution of the present invention is higher as compared to the water flux by means of forward osmosis from the wastewater to the conventional electrolyte solution, indicating that the electrolyte solution of the present invention which act as a draw solution increases the efficiency of the forward osmosis process.

As a whole, the electrolyte solution of the present invention is able to increase the hydrogen and oxygen production rate at lower power consumption.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups therefrom.

The method steps, processes, and operations described herein are not to be construed as necessarily requiring their performance in the particular order discussed or illustrated, unless specifically identified as an order of performance. It is also to be understood that additional or alternative steps may be employed. The use of the expression “at least” or “at least one” suggests the use of one or more elements, as the use may be in one of the embodiments to achieve one or more of the desired objects or results.

1. An electrolyte solution comprising:
an electrolyte, wherein the electrolyte is used in an amount ranging between 1 wt % to 10 wt % of the electrolyte solution;
an ionic liquid, wherein the ionic liquid is used in an amount ranging between 1 wt % to 5 wt % of the electrolyte solution; and
a solvent, wherein the solvent is used in an amount ranging between 75 wt % to 98 wt % of the electrolyte solution.

2. The electrolyte solution as claimed in claim 1, wherein the electrolyte solution further comprises an additive and wherein the additive is used in an amount ranging between 0 wt % to 10 wt % of the electrolyte solution.

3. The electrolyte solution as claimed in claim 1, wherein the electrolyte is selected from the group consisting of potassium hydroxide, sodium hydroxide, sodium chloride and mixtures thereof.

4. The electrolyte solution as claimed in claim 1, wherein the ionic liquid is selected from the group consisting of 1-ethyl-3-methylimidazolium trifluoromethanesulfonate, 1-ethyl-3-methylimidazolium methanesulfonate (Emim·MeSO₃) and mixtures thereof.

5. The electrolyte solution as claimed in claim 1, wherein the solvent is deionized water.

6. The electrolyte solution as claimed in claim 2, wherein the additive is sodium saccharin.
